(19) United States
(12) Patent Application Publication
(10) Pub. No.: US 2024/0317648 A1
(43) Pub. Date: Sep. 26, 2024

(54) METHODS OF MANUFACTURING GREEN BODIES AND SUBSTRATES

(71) Applicant: MICROTECH CERAMICS LIMITED, Loughborough Leicestershire (GB)

(72) Inventors: Benjamin Francis Knatchbull KINGSBURY, Rotherfield Sussex (GB); Nadia CROESER, Ruddington Nottinghamshire (GB); Dean Graeme OXLEY, Mansfield Nottinghamshire (GB)

(21) Appl. No.: 18/579,201

(22) PCT Filed: Jul. 14, 2022
(86) PCT No.: PCT/GB2022/051826

§ 371 Date: Jan. 12, 2024

(30) Foreign Application Priority Data
Jul. 15, 2021 (GB) 2110213.2

(51) Int. Cl. C04B 35/626; B01D 53/94; B01D 67/00; B01D 69/08; C04B 35/622; C04B 35/634; C04B 35/638; C04B 35/64; C04B 41/00; F01N 3/28

(52) U.S. Cl. CPC C04B 35/6264; B01D 53/94; B01D 67/00411; B01D 69/08; C04B 35/62227; C04B 35/634; C04B 35/638; C04B 35/64; C04B 41/0072; F01N 3/2825; F01N 3/2835; B01D 2258/012; B01D 2259/4566; C04B 2235/6021; F01N 2330/06; F01N 2330/10; F01N 2330/14

(57) ABSTRACT

A method of manufacturing a green body, the method comprising:
providing:
a third composition comprising a second substrate material, a third polymer, a fusing agent, and a third solvent;
forming the third composition into a structure wherein the third composition forms a third layer; and
contacting the third layer with a fourth solvent in which the third polymer is insoluble to precipitate said polymer, thereby forming a green body.

A substrate is further manufactured by:
arranging a plurality of green bodies to form an assembly of green bodies;
   fusing the green bodies in the assembly together, thereby forming a precursor substrate; and
sintering the precursor substrate, thereby forming a substrate.

### FIELD

The present invention relates to methods of manufacturing green bodies, substrates, filters, catalytic convertors, exhaust systems, and products including an internal combustion engine (such as vehicles), and products made by such methods. In particular, the invention relates to a method of manufacturing a green body from a multilayer structure and to a method of manufacturing a substrate.

### BACKGROUND

The combustion of fuel in internal combustion engines (present in various products, especially vehicles) results in the production of exhaust gases which contain pollutants which are harmful to human health and the environment. Modern vehicles (and other products including internal combustion engines) are therefore equipped with exhaust systems designed to reduce such pollutants. For example, vehicle exhaust systems typically comprise catalytic convertors for reducing the emission of carbon monoxide, hydrocarbons and nitrogen oxides (NOx), and for example diesel particulate filters (DPF) or gasoline particulate filters (GPF) for reducing the emission of soot.

Known catalytic convertors comprise a ceramic substrate having a catalytically active coating applied thereon (which catalytically active coating may comprise a platinum group metal (PGM)). The effectiveness of these substrates on exhaust gases is limited by the geometrical surface area of the substrate.

Known diesel particulate and gasoline particulate filters also comprise a ceramic substrate, which substrate is adapted to capture and store exhaust particulates (such as soot) present in the exhaust gases, thereby reducing the emission of such particulates. The substrates of such filters may also comprise a catalytically active coating applied thereon.

Other filters are known (such as water filters) that comprise a ceramic substrate. Such a filter may not comprise a catalytically active coating but may have a coating applied thereto that aids filtration and, for example, cleansing.

Conventional ceramic substrates comprise numerous channels through which fluids such asexhaust gases or liquids (for example water) pass. The substrates are also porous, such that the walls of the channels comprise pores. The channel structure of the substrate provides a large geometric surface area (GSA), which may support a highly porous, high surface area washcoat. A coating, such as a catalytically active coating, can be deposited on or in the washcoat, thereby providing the substrate with a desired functionality, such as catalytic convertor functionality. The coated substrate must also provide desirable flow characteristics. For example, in the case of a catalytic convertor, the coated substrate must provide desirable gas flow characteristics so as to provide the required gas-catalyst contact without excessive back pressure which may be detrimental to the performance of an internal combustion engine in which the substrate is assembled.

Alternative ceramic substrates are described in WO 2013/175239 and WO 2015/033157.

WO2013/175239 discloses a catalytic convertor substrate comprising a plurality of micro-structured tubes having a large geometric surface area. The tubes have a surface with openings to micro-channels extending towards another surface, preferably terminating within the tube cross-section so that the tube comprises a solid layer that provides rigidity. The tubes are manufactured by a combined phase inversion and sintering technique. The tubes are arranged in a parallel tightly packed bundle and may be glued together or bound together using a strap or insulation mat.

WO2015/033157 discloses catalytic convertor substrates other than micro-structured tubes. The substrates have a surface with openings to micro-channels that extend away from said surface. The substrates are manufactured by a combined phase inversion and sintering technique. In order to ensure that the micro-channels extend all the way through the substrate, at least a portion of a surface layer of the green body may be removed, for example, by applying heat, by using a blade, by using an abrasive, by sanding, or by contact with a solvent.

It is one aim of the present invention, among others, to provide a method of manufacturing green bodies and substrates that addresses at least one disadvantage of the prior art, whether identified here or elsewhere, or to provide an alternative to existing methods of manufacturing green bodies and substrates. For instance, it may be an aim of the present invention to provide a method of manufacturing a substrate which facilitates the fusing of a plurality of green bodies.

### SUMMARY OF THE INVENTION

According to a first aspect of the invention, there is provided a method of manufacturing a green body, the method comprising:
providing:
a third composition comprising a second substrate material, a third polymer, a fusing agent, and a third solvent;
forming the third composition into a structure wherein the third composition forms a third layer; and
contacting the third layer with a fourth solvent in which the third polymer is insoluble to precipitate said polymer, thereby forming a green body.

According to a second aspect of the invention, there is provided a method of manufacturing a green body, the method comprising:
providing:
a first composition comprising a first polymer and a first solvent, wherein the first polymer is soluble in the first solvent,
a third composition comprising a second substrate material, a third polymer, a fusing agent, and a third solvent, wherein the third polymer is soluble in the first solvent and the third solvent;
forming the first composition and the third composition into a multilayer structure wherein the first composition forms a first layer and the third composition forms a third layer;
contacting the multilayer structure with a fourth solvent in which the first polymer and third polymer are insoluble to precipitate said polymers, thereby forming a green body.

According to a third aspect of the invention, there is provided a method of manufacturing a green body, the method comprising:
providing:
a first composition comprising a first polymer and a first solvent, wherein the first polymer is soluble in the first solvent,
a second composition comprising a first substrate material, a second polymer and a second solvent, wherein the second polymer is soluble in the first solvent and the second solvent, and
a third composition comprising a second substrate material, a third polymer, a fusing agent, and a third solvent, wherein the third polymer is soluble in the first solvent and the third solvent;
forming the first composition, the second composition and the third composition into a multilayer structure wherein the first composition forms a first layer, the second composition forms a second layer, and the third composition forms a third layer and the second layer is adjacent to the third layer; and
contacting the multilayer structure with a fourth solvent in which the first polymer, second polymer, and third polymer are insoluble to precipitate said polymers, thereby forming a green body.

According to a fourth aspect of the invention, there is provided a green body obtained by the method of the first, second or third aspect of the invention.

According to a fifth aspect of the invention, there is provided a method of manufacturing a substrate, the method comprising the steps of:
manufacturing a green body according to the first, second or third aspect of the invention;
arranging the green body with a plurality of the green bodies to form an assembly of green bodies;
fusing the green bodies in the assembly together, thereby forming a precursor substrate; and
sintering the precursor substrate, thereby forming a substrate.

According to a sixth aspect of the invention, there is provided a substrate obtained by the method of the fifth aspect of the invention.

According to a seventh aspect of the invention, there is provided a method of manufacturing a filter, the method comprising manufacturing a substrate according to the fifth aspect of the invention and blocking at least some macro-channels in the substrate.

According to an eighth aspect of the invention, there is provided a method of filtering, the method comprising manufacturing a filter according to the seventh aspect of the invention and passing a composition through the filter.

According to a ninth aspect of the invention, there is provided a filter comprising a substrate according to the sixth aspect of the invention.

According to a tenth aspect of the invention, there is provided a method of manufacturing a catalytic convertor, the method comprising manufacturing a substrate according to the fifth aspect of the invention and depositing a catalytic species or precursor thereof on the substrate.

According to an eleventh aspect of the invention, there is provided a method of catalytic conversion of pollutants, the method comprising manufacturing a catalytic convertor according to the tenth aspect of the invention and passing a pollutant composition through the catalytic convertor.

According to a twelfth aspect of the invention, there is provided a catalytic convertor comprising a substrate according to the sixth aspect of the invention.

According to a thirteenth aspect of the invention, there is provided a method of manufacturing an exhaust system, the method comprising:
manufacturing a filter according to the seventh aspect of the invention and incorporating the filter into an exhaust system; and/or
manufacturing a catalytic convertor according to the tenth aspect of the invention and incorporating the catalytic convertor into an exhaust system.

According to a fourteenth aspect of the invention, there is provided an exhaust system comprising a filter according to the ninth aspect of the invention and/or a catalytic convertor according to the twelfth aspect of the invention.

According to a fifteenth aspect of the invention, there is provided a method of manufacturing a product including an internal combustion engine (such as a vehicle), the method comprising manufacturing an exhaust system according to the thirteenth aspect of the invention and incorporating the exhaust system into a product including an internal combustion engine (such as a vehicle).

According to a sixteenth aspect of the invention, there is provided a product including an internal combustion engine (such as a vehicle) comprising an exhaust system according to the fourteenth aspect of the invention.

### DETAILED DESCRIPTION

Unless otherwise stated, the following terms used in the specification and claims have the meanings set out below.

As used herein, the term “ceramic” is used in its ordinary sense, which is well-known to those skilled in the art. Specifically, a ceramic is an inorganic, nonmetallic solid, generally based on an oxide, nitride, boride, or carbide, that is fired at a high temperature.

As used herein, the term “substrate” is used in its ordinary sense, which is well-known to those skilled in the art. Specifically, a substrate is an underlying substance upon which another substance, such as a washcoat, may be applied. In some embodiments, a substrate may be used without another substance applied, such as without a washcoat applied. The substrate may take any suitable form, such as a tubular, non-tubular, or sheet form. The substrate May comprise a plurality of fused hollow fibres, preferably a plurality of parallel, fused hollow fibres. Such substrates may comprise channels that are open macro-channels within the hollow fibres (e.g. the bore of the hollow fibres), as well as micro-channels in the porous walls of the hollow fibres.

By “macro-channels” we mean channels penetrating through the substrate having a minimum diameter (i.e. at the narrowest part of the channel) of greater than 0.2 mm, such as greater than 5 mm, or even greater than 1 mm. References herein to “channels” are intended to refer to macro-channels.

By “micro-channels” we mean channels penetrating through the walls of the macro-channels having an entrance diameter of 5 μm to 200 μm.

The walls of the substrate are porous, i.e. comprise pores. Pore diameters are typically less than 5 μm, such as from 0.1 to 4.9 μm.

As used herein, the term “green body” is used in its ordinary sense, which is well-known to those skilled in the art. Specifically, by “green body” we mean a precursor to a substrate that has not yet been heat-treated or sintered.

As used in the specification and the appended claims, the singular forms “a”, “an,” and “the” include both singular and plural referents unless the context clearly dictates otherwise. By way of example, “a catalytic species” means one catalytic species or more than one catalytic species.

Throughout this specification, the term “comprising” or “comprises” means including the component(s) specified but not to the exclusion of the presence of other components. The term “consisting essentially of” or “consists essentially of” means including the components specified but excluding other components except for components added for a purpose other than achieving the technical effect of the invention. The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

For the avoidance of doubt, where amounts of components in a composition are described in wt %, this means the weight percentage of the specified component in relation to the whole composition referred to.

As used herein, unless otherwise expressly specified, all numbers such as those expressing values, ranges, amounts of percentages may be read as if prefaced by the word “about”, even if the term does not expressly appear.

The term “about” as used herein when referring to a measurable value such as a parameter, an amount, a temporal duration, and the like, indicate that a value includes the standard deviation of error for the device or method being employed to determine the value. The term “about” is meant to encompass variations of +/−10% or less, +/−5% or less, or +/−0.1% or less of and from the specified value, insofar such variations are appropriate to perform in the disclosure. It is to be understood that the value to which the modifier “about” refers is itself also specifically disclosed.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The optional features set out herein may be used either individually or in combination with each other where appropriate and particularly in the combinations as set out in the accompanying claims. The optional features for each exemplary embodiment of the invention, as set out herein are also applicable to any other aspects or exemplary embodiments of the invention, where appropriate. In other words, the skilled person reading this specification should consider the optional features for each aspect or embodiment of the invention as interchangeable and combinable between different aspects of the invention.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

According to a first aspect of the invention, there is provided a method of manufacturing a green body, the method comprising:

providing:
a third composition comprising a second substrate material, a third polymer, a fusing agent, and a third solvent;
forming the third composition into a structure wherein the third composition forms a third layer; and
contacting the third layer with a fourth solvent in which the third polymer is insoluble to precipitate said polymer, thereby forming a green body.

According to a second aspect of the invention, there is provided a method of manufacturing a green body, the method comprising:
providing:
a first composition comprising a first polymer and a first solvent, wherein the first polymer is soluble in the first solvent,
a third composition comprising a second substrate material, a third polymer, a fusing agent, and a third solvent, wherein the third polymer is soluble in the first solvent and the third solvent;
forming the first composition and the third composition into a multilayer structure wherein the first composition forms a first layer and the third composition forms a third layer; and
contacting the multilayer structure with a fourth solvent in which the first polymer and third polymer are insoluble to precipitate said polymers, thereby forming a green body.

According to a third aspect of the invention, there is provided a method of manufacturing a green body, the method comprising:
providing:
a first composition comprising a first polymer and a first solvent, wherein the first polymer is soluble in the first solvent,
a second composition comprising a first substrate material, a second polymer and a second solvent, wherein the second polymer is soluble in the first solvent and the second solvent, and
a third composition comprising a second substrate material, a third polymer, a fusing agent, and a third solvent, wherein the third polymer is soluble in the first solvent and the third solvent;
forming the first composition, the second composition and the third composition into a multilayer structure wherein the first composition forms a first layer, the second composition forms a second layer, and the third composition forms a third layer and the second layer is adjacent to the third layer; and
contacting the multilayer structure with a fourth solvent in which the first polymer, second polymer, and third polymer are insoluble to precipitate said polymers, thereby forming a green body.

The “first composition” and “first layer” of the multilayer structure or green body in any aspect of the present invention may alternatively be referred to as a “sacrificial composition” or “sacrificial layer”, respectively. The “first polymer” and “first solvent” may alternatively be referred to as the “polymer of the sacrificial composition” or “solvent of the sacrificial composition”, respectively. The method of the first aspect of the invention may comprise providing a first composition and additionally forming a first layer to form a multilayer structure (suitably as defined in the method of the second aspect of the invention).

The “second composition” and “second layer” of the multilayer structure or green body in any aspect of the present invention may alternatively be referred to as a “support composition” or “support layer”, respectively. The “first substrate material”, “second polymer” and “second solvent” may alternatively be referred to as the “substrate material of the support composition”, the “polymer of the support composition” or the “solvent of the support composition”, respectively. The presence of a second composition and corresponding second layer in any aspect, in particular the third aspect of the invention advantageously provides structural support for the third layer and helps the green body to retain its shape when being fused to other green bodies.

The “third composition” and “third layer” of the structure (such as the multilayer structure) or green body in any aspect of the present invention may alternatively be referred to as a “fusing composition” or “fusing layer”, respectively. The “second substrate material”, “third polymer” and “third solvent” may alternatively be referred to as the “substrate material of the fusing composition”, the “polymer of the fusing composition” or the “solvent of the fusing composition”, respectively. The method of the first aspect of the invention may comprise providing a second composition and additionally forming a second layer to form a multilayer structure. The structure defined in the first aspect may be referred to as a multilayer structure when the structure comprises a first layer and/or second layer in addition to the third layer. For the avoidance of doubt, by “(multilayer) structure” we mean a structure comprising a third layer, or a multilayer structure comprising a third layer and a first layer and/or second layer. The method of the second aspect of the invention may comprise providing a second composition and additionally forming a second layer in the multilayer layer structure (suitably as defined in the method of the third aspect of the invention).

References herein to a polymer or substrate material being (in)soluble or poorly soluble in a solvent mean that the polymer or substrate material is (in)soluble or poorly soluble in the solvent at a temperature of 25° C. and at a pressure of 100 kPa.

Suitably, a polymer that is soluble in a solvent has a solubility of at least 10 g/L in the solvent, such as at least 100 g/L, in the solvent at a temperature of 25° C. and at a pressure of 100 kPa. Suitably, a polymer that is poorly soluble in a solvent has a solubility of at least 1 g/L and less than 10 g/L, such as from 2 to 8 g/L in the solvent at a temperature of 25° C. and at a pressure of 100 kPa. Suitably, a polymer or substrate material that is insoluble in a solvent has a solubility of less than 1 g/L in the solvent, such as less than 0.1 g/L, in the solvent at a temperature of 25° C. and at a pressure of 100 kPa.

Alternatively, the solubility of a polymer or substrate material may be defined using Hansen solubility parameters. Hansen solubility parameters represent forces between two molecules (such as a polymer and a solvent). The use of Hansen solubility parameters is well known to those skilled in the art. The distance between the Hansen solubility parameters (Ra) of two molecules is calculated as follows:

$${Ra}^{2} = 4 {( δ {D}_{1} - δ {D}_{2} )}^{2} + {( δ {P}_{1} - δ {P}_{2} )}^{2} + {( δ {H}_{1} - δ {H}_{2} )}^{2}$$

wherein δD represents dispersion forces between the molecules, OP represents polar forces between the molecules and OH represents hydrogen bonding forces between the molecules.

The relative energy difference (RED) is calculated as follows:

$$RED = Ra / {R}_{0}$$

wherein R₀ is an experimentally determined interaction radius.

Suitably, a polymer and a solvent in which the polymer is soluble have a RED of less than 0.9. Suitably, a polymer and a solvent in which the polymer is poorly soluble have a RED of from 0.9 to 1, preferably 1. Suitably, a polymer or substrate material and a solvent in which the polymer or substrate material is insoluble have a RED of greater than 1.

The inventors have found that manufacturing a green body using optionally a first composition, optionally a second composition and a third composition according the first, second and third aspects of the invention results in a green body that has several advantages.

The precipitation (i.e. phase inversion) of the polymers in the multilayer structure results in the formation of openings in a surface of the green body with micro-channels extending away from the openings. This is believed to be due to the egress of the first, second (when present) and third solvents and ingress of the fourth solvent. These micro-channels provide the green body, and the eventual substrate formed from the green body, with a large geometric surface area. However, the micro-channels typically do not extend all of the way from one surface of the green body to the other upon precipitation of the polymers.

The inventors have found that including a first composition in the multilayer structure in addition to the substrate material-containing second (when present) and third compositions suitably causes the micro-channels to penetrate through at least the layers formed from the second (when present) and third compositions when phase inversion is carried out. Although the micro-channels may terminate in the layer formed from the first composition, said layer can advantageously be removed from the green body, especially when said layer does not comprise a substrate material, so that the remaining green body advantageously has micro-channels penetrating from one surface of the green body to another. Such micro-channels improve the gas flow through the green body and the eventual substrate. When the first composition is not included in the multilayer structure, the micro-channels may terminate in the layer formed from the second composition (when present) or the third composition. This may be desirable if the green body is intended to be used for manufacturing a filter.

In addition, the inventors have found that including a fusing agent in the third composition advantageously allows the green body to be fused with other green bodies manufactured according to the methods of the first, second and third aspects of the invention. Fusing of the green bodies may be conducted in a controlled manner, for example by exposing the green bodies to a stimulus, such as a high temperature. Using a combination of the third polymer and the fusing agent in the third composition allows the third layer of the green body (precipitated from the third composition) to retain its shape in the absence of high temperatures or other stimuli, thereby preserving the geometry of the multilayer structure, while being able to fuse with third layers of other green bodies. A layer formed from the third polymer in the absence of the fusing agent would retain its shape, but would not be fusable with other green bodies.

In the methods of the first, second and third aspects of the invention, the (multilayer) structure comprises a first layer (when present), a second layer (when present) and a third layer formed from the first composition (when present), the second composition (when present) and the third composition, respectively. The green body formed by precipitation of the polymers in the (multilayer) structure comprises a first layer (when present), a second layer (when present) and a third layer corresponding to the first layer (when present), the second layer (when present) and the third layer, respectively, of the (multilayer) structure. The layer(s) of the green body suitably differ from the layer(s) of the (multilayer) structure in that the layer(s) of the green body are solid and are substantially free from the first solvent (when present), the second solvent (when present) and the third solvent. By “substantially free” from a solvent, we mean that the solvent is not present in an amount of more than 1 wt %, preferably 0.1 wt %, or even 0.01 wt % based on the total weight of the green body.

The method of the first aspect may comprise:
providing:
a first composition comprising a first polymer and a first solvent,
a third composition comprising a second substrate material, a third polymer, a fusing agent, and a third solvent, wherein the third polymer is soluble in the first solvent and the third solvent;
forming the first composition and the third composition into a multilayer structure wherein the first composition forms a first layer and the third composition forms a third layer; and contacting the multilayer structure with a fourth solvent in which the first polymer and third polymer are insoluble to precipitate said polymers, thereby forming a green body

The first composition comprises a first polymer and a first solvent, wherein the first polymer is preferably soluble in the first solvent. In the method of the second and third aspects, the first polymer is soluble in the first solvent. Suitably, the first composition comprises from 5 to 70 wt %, such as from 8 to 50 wt %, or even from 10 to 30 wt %, of the first polymer and from 95 to 30 wt %, such as from 92 to 50 wt %, or even from 90 to 70 wt %, of the first solvent.

The method of the first aspect may comprise:
providing:
a second composition comprising a first substrate material, a second polymer and a second solvent, wherein the second polymer is soluble in the second solvent, and
a third composition comprising a second substrate material, a third polymer, a fusing agent, and a third solvent, wherein the third polymer is soluble in the third solvent;
forming the second composition and the third composition into a multilayer structure wherein the second composition forms a second layer and the third composition forms a third layer; and
contacting the multilayer structure with a fourth solvent in which the second polymer and third polymer are insoluble to precipitate said polymers, thereby forming a green body.

The method of the first aspect may comprise:
providing:
a first composition comprising a first polymer and a first solvent,
a second composition comprising a first substrate material, a second polymer and a second solvent, wherein the second polymer is soluble in the second solvent, and
a third composition comprising a second substrate material, a third polymer, a fusing agent, and a third solvent, wherein the third polymer is soluble in the third solvent;
forming the first composition, the second composition and the third composition into a multilayer structure wherein the first composition forms a first layer, the second composition forms a second layer, and the third composition forms a third layer and the second layer is adjacent to the third layer; and
contacting the multilayer structure with a fourth solvent in which the first polymer, second polymer, and third polymer are insoluble to precipitate said polymers, thereby forming a green body.

The second composition comprises a first substrate material, a second polymer and a second solvent, wherein the second polymer is preferably soluble in the first solvent (when present) and soluble in the second solvent. In the method of the second and third aspects, the second polymer is soluble in the first solvent. The solubility of the second polymer in the first solvent advantageously helps the micro-channels penetrate into the first layer of the multilayer structure, especially when the second layer is adjacent to the first layer. Suitably, the second composition comprises from 5 to 40 wt %, such as from 6 to 25 wt %, or even from 8 to 15 wt %, of the second polymer, from 20 to 60 wt %, such as from 27 to 55 wt %, or even from 35 to 50 wt %, of the second solvent and from 20 to 60 wt %, such as from 27 to 55 wt %, or even from 35 to 50 wt %, of the first substrate material.

In some embodiments, the method of the first aspect does not comprise providing a first composition as defined herein. In such embodiments, the (multilayer) structure does not comprise a first layer. The structure may consist of the third layer, or the multilayer structure may consist of the second layer and the third layer. When a (multilayer) structure which does not comprise a first layer is contacted with the fourth solvent, the micro-channels formed suitably terminate in the second layer (when present) or the third layer.

The third composition comprises a second substrate material, a third polymer, a fusing agent, and a third solvent, wherein the third polymer is preferably soluble in the first solvent (when present) and soluble in the third solvent. In the method of the second and third aspects, the third polymer is soluble in the first solvent. The solubility of the third polymer in the first solvent advantageously helps the micro-channels penetrate into the first layer of the multilayer structure, especially when the third layer is adjacent to the first layer. Suitably, the third composition comprises from 5 to 40 wt %, such as from 6 to 25 wt %, or even from 8 to 15 wt %, of the third polymer, from 5 to 40 wt %, such as from 6 to 25 wt %, or even from 8 to 15 wt %, of the fusing agent, from 20 to 60 wt %, such as from 27 to 55 wt %, or even from 35 to 50 wt %, of the third solvent and from 20 to 60 wt %, such as from 27 to 55 wt %, or even from 35 to 50 wt % of the second substrate.

Suitably, second substrate material is present in the third composition in an amount of from 60 to 95 wt %, such as from 63 to 85 wt %, or even from 66 to 75 wt %, based on the total solid weight of the third composition. By “solid weight” we mean the weight excluding the weight of solvents.

The first polymer is suitably immiscible with at least one of the second polymer (when present) and the third polymer. By “immiscible” we mean that the polymers do not form a substantially homogeneous mixture when stirred together in the first solvent at a temperature of 25° C. and a pressure of 100 kPa. By “substantially homogeneous mixture”, we mean a mixture in which at least 80 vol %, such as at least 90 vol %, or even at least 95 vol %, of the mixture is homogeneous, e.g. does not contain phase separation.

Suitably, the first polymer is immiscible with any polymer in a layer adjacent to the first layer in the multilayer structure. For example, when the first layer is adjacent to the second layer in the multilayer structure, the first polymer is suitably immiscible with the second polymer. Preferably, the first polymer is immiscible with the second polymer and the third polymer. Suitably, the first polymer is immiscible with all other polymers in the multilayer structure.

The lack of miscibility between the first polymer and other polymers in the green body facilitates removal of the first layer from the green body to expose openings to micro-channels in the green body.

Suitably, the first polymer is insoluble in the second solvent (if present) and/or the third solvent. Suitably, the first polymer is insoluble in any solvent in a layer adjacent to the first layer in the multilayer structure. For example, when the first layer is adjacent to the second layer in the multilayer structure, the first polymer is suitably insoluble in the second solvent. Preferably, the first polymer is insoluble in the second solvent and the third solvent. Suitably, the first polymer is insoluble in all solvents in the multilayer structure other than the first solvent.

The insolubility of the first polymer in solvents of other layers in the green body facilitates removal of the first layer from the green body to expose openings to micro-channels in the green body. If the first layer is not intended to be removed, the first polymer may be soluble in the solvents of other layers and/or miscible with the polymers of other layers.

The first composition may further comprise a substrate material. The substrate material of the first composition may comprise one or more of: a ceramic, cordierite, zirconia, yttrium-stabilised zirconia, titania, silicon carbide, clay, alumina, stainless steel, FeCr alloys, alloys of iron, alloys of aluminium, aluminium titanate, sintered metals, or a zeolite. Preferably, the substrate material comprises a ceramic.

When the first composition comprises a substrate material, the first composition suitably comprises from 5 to 40 wt %, such as from 6 to 25 wt %, or even from 8 to 15 wt %, of the first polymer, from 20 to 60 wt %, such as from 27 to 55 wt %, or even from 35 to 50 wt %, of the first solvent and from 20 to 60 wt %, such as from 27 to 55 wt %, or even from 35 to 50 wt %, of the substrate material.

In some embodiments, the micro-channels do not penetrate into the first layer on precipitation of the polymers in the multilayer structure. Such embodiments may be advantageous for the manufacture of filters, since the first layer will be able to filter smaller particles than any layers comprising micro-channels. The micro-channels may be prevented from penetrating into the first layer by an insufficient amount of the first solvent in the first composition, or poor solubility of the first polymer in the first solvent. By “insufficient amount” we mean that the first composition may comprise up to 20 wt %, such as up to 10 wt %, or even up to 5 wt % of the first solvent. The first polymer may be poorly soluble in the first solvent. A first solvent in which the first polymer is poorly soluble may be prepared by mixing a solvent in which the first polymer is soluble with a solvent in which the first polymer is insoluble, wherein the two solvents are miscible.

The first composition is preferably different from the second composition (when present) and the third composition. When the first composition comprises a substrate material, the substrate material of the first composition is preferably different from the substrate material in the layer adjacent to the first layer in the multilayer structure. Suitably, the substrate material of the first composition has a different particle size from the substrate material of the layer adjacent to the first layer in the multilayer structure. For example, the substrate material of the first composition may have a larger particle size than the substrate material of the layer adjacent to the first layer in the multilayer structure. A larger particle size typically corresponds to a larger pore size in the substrate prepared from the green body. Such an embodiment may be advantageous for the manufacture of filters, as the larger particle size and corresponding larger pore size of the first layer enables fluid to more easily pass through the first layer to/from a micro-channel, especially when the green body comprises micro-channels terminating in the first layer.

Alternatively, the first composition may be substantially free from a substrate material. By “substantially free” from a substrate material, we mean that a substrate material is not present in an amount of more than 1 wt %, preferably 0.1 wt %, or even 0.01 wt %, based on the total weight of the first composition. Such an embodiment may be preferred if the first layer is intended to be removed.

Preferably, the second polymer and the third polymer are the same. This improves the binding between the second layer and the third layer in the green body.

The second polymer and/or the third polymer suitably has a glass transition temperature above 25° C., such as above 50° C., such as above 100° C., or even above 200° C.

The fusing agent may comprise any suitable additive that enables the third layer of the green body to be fused to the third layer of other green bodies on exposure to a stimulus, such as heat or a solvent. Suitably, the fusing agent causes softening of the third layer of the green body (e.g. as measured by Shore Hardness, ASTM D2240) on exposure to a stimulus. For example, the fusing agent may comprise a fourth polymer having a lower glass transition temperature than the third polymer (causing softening of the third layer on exposure to heat), or the fusing agent may comprise a temperature-activated catalyst (causing softening of the third layer on exposure to heat), or the fusing agent may be soluble in a fifth solvent in which the third polymer is insoluble (causing softening of the third layer on exposure to the fifth solvent).

The fusing agent suitably comprises a fourth polymer having a glass transition temperature below 25° C., such as below 20° C., such as below 15° C., or even below 10° C.

The fourth polymer is suitably soluble in first solvent (when present) and the third solvent. The fourth polymer is suitably insoluble in the fourth solvent.

The fusing agent is suitably miscible with the third polymer. By “miscible” we mean that the fusing agent and the third polymer form a substantially homogeneous mixture when stirred together in the third solvent at a temperature of 25° C. and a pressure of 100 kPa. This reduces the likelihood of the fusing agent and third polymer agglomerating in the third composition and improves the processability of the third composition.

The fusing agent may be present in the third composition in an amount of from 10 to 90 wt %, such as from 20 to 80 wt %, or even from 40 to 60 wt %, based on the total weight of the third polymer and the fusing agent in the third composition. For the avoidance of doubt, when the fusing agent is present in an amount of 10 wt % the third polymer is present in an amount of 90 wt % based on the total weight of the third polymer and the fusing agent in the third composition.

The 16 second composition is preferably substantially free from the fusing agent. By “substantially free” from the fusing agent, we mean that the fusing agent is not present in an amount of more than 1 wt %, preferably 0.1 wt %, or even 0.01 wt %, based on the total weight of the second composition.

Suitably, the first polymer (when present), the second polymer (when present), the third polymer and the fourth polymer (when present) are each organic polymers. By “organic polymers” we mean polymers comprising carbon atoms in the backbone.

The first polymer may comprise a polyester. Suitably, the first polymer comprises an aliphatic polyester, such as polycaprolactone.

The first polymer suitably has a number average molecular weight (Mn) or a weight average molecular weight (Mw) of from 5,000 to 200,000 g/mol, such as from 10,000 to 120,000 g/mol, or even from 20,000 to 80,000 g/mol.

The second polymer (when present) and/or the third polymer may each independently comprise one or more of polyethersulfone, polysulfone, cellulose and its derivatives, polyamide, polyetherimide, polyimide and its derivatives, polyvinylidene fluoride, and polydimethylsiloxane. Preferably, the second polymer and/or the third polymer comprises polyethersulfone.

The second polymer and/or the third polymer suitably independently have a number average molecular weight (Mn) or a weight average molecular weight (Mw) of from 5,000 to 200,000 g/mol, such as from 10,000 to 120,000 g/mol, or even from 20,000 to 80,000 g/mol.

The fourth polymer may comprise an epoxy resin. Suitable epoxy resins include bisphenol-based epoxy resins, such as bisphenol A-based epoxy resins. Preferably, the fourth polymer comprises bisphenol A diglycidyl ether.

The fourth polymer suitably has a number average molecular weight (Mn) or a weight average molecular weight (Mw) of from 200 to 5,000 g/mol, such as from 400 to 3,000 g/mol, or even from 600 to 1,000 g/mol.

The first substrate material is suitably insoluble in the second solvent such that the first substrate material is present as a suspension in the second solvent in the second composition. The second substrate material is suitably insoluble in the third solvent such that the second substrate material is present as a suspension in the third solvent in the third composition.

The first substrate material (when present) and/or the second substrate material may each independently comprise one or more of: a ceramic, cordierite, zirconia, yttrium-stabilised zirconia, titania, silicon carbide, clay, alumina, stainless steel, FeCr alloys, alloys of iron, alloys of aluminium, aluminium titanate, sintered metals, or a zeolite. Preferably, the first substrate material and/or the second substrate material comprises a ceramic. Preferably, the first substrate material and the second substrate material are the same.

The first substrate material and/or the second substrate material may have a particle size of from 0.01 to 10 μm, such as from 0.05 to 5 μm, or even from 0.1 to 1 μm.

The first solvent (when present), the second solvent (when present) and/or the third solvent may each independently comprise an organic solvent, such as a dipolar aprotic solvent. Suitable dipolar aprotic solvents include acetonitrile, acetone, dimethylformamide, dimethylacetamide, hexamethylphosphoramide, N-methyl-2-pyrrolidone and dimethyl sulfoxide. Preferably, the second solvent and/or the third solvent each independently comprise N-methyl-2-pyrrolidone and/or dimethyl sulfoxide. Suitably, the second solvent and the third solvent are the same.

The fourth solvent may alternatively be referred to as the non-solvent. The fourth solvent suitably comprises a polar protic solvent, such as water. Preferably the fourth solvent comprises water.

The second composition (when present) and/or the third composition may further comprise a dispersant. The dispersant is suitably effective to disperse the first substrate material in the second solvent and/or to disperse the second substrate material in the third solvent. Suitable dispersants are well known to persons skilled in the art and include polyalkylene glycols (such as polyethylene glycol), PEG-30 dipolyhydroxystearate (e.g. Cithrok® DPHS), Schwego® Wett 8082, alkylolammonium salt co-polymer (e.g. Disperbyk-180), and phosphoric ester salt (e.g. Disperbyk-145).

The methods of the first, second and third aspects of the invention suitably further comprise degassing the first composition (when present), the second composition (when present) and the third composition (“the compositions”) prior to formation of the (multilayer) structure. Degassing the compositions prevents dissolved gas or gas bubbles from disrupting the formation of the micro-channels in the green body during the precipitation of the green body. Degassing the compositions suitably comprises subjecting the compositions to a vacuum, for example a pressure of less than 10,000 Pa, such as less than 6,600 Pa, or even less than 3,300 Pa. Degassing the compositions may comprise subjecting the compositions to a pressure of from 10,000 to 0.1 Pa, such as from 6,600 to 0.3 Pa, or even from 3,300 to 0.4 Pa.

The methods of the first, second and third aspects of the invention comprise forming the first composition (when present), the second composition (when present) and the third composition into a (multilayer) structure wherein the first composition (when present) forms a first layer, the second composition (when present) forms a second layer, and the third composition forms a third layer.

In the third aspect of the invention, the second layer is adjacent to the third layer in the multilayer structure. The first layer may be adjacent to the second layer and/or the third layer in the multilayer structure. For example, the second layer in the multilayer structure may be adjacent to the first layer and adjacent to the third layer (such that the second layer is in between the first layer and the third layer), or the third layer in the multilayer structure may be adjacent to the first layer and adjacent to the second layer (such that the third layer is in between the first layer and the second layer). Preferably, the second layer is adjacent to the first layer and is adjacent to the third layer in the multilayer structure.

In embodiments of the first and second aspects of the invention where the multilayer structure comprises a first layer, a second layer and a third layer, the arrangement of the layers is suitably as described above for the third aspect.

Adjacent layers in the multilayer structure are suitably in contact with one another. For example, the second layer is suitably in contact with the third layer. This reduces the likelihood that the layers become detached from each other when the green body is formed. In embodiments of the first of the invention where the structure is a multilayer structure comprising at least two layers (such as the third layer and the first layer or the second layer), the layers are preferably in contact with one another.

The first layer (when present) may be present in the green body in an amount of from 1 to 30% by bulk volume, such as from 5 to 25% by bulk volume, or even from 10 to 20% by bulk volume, based on the total bulk volume of the green body. The second layer (when present) may be present in the green body in an amount of from 20 to 90% by bulk volume, such as from 40 to 70% by bulk volume, or even from 50 to 60% by bulk volume, based on the total bulk volume of the green body. The third layer (when another layer is present) may be present in the green body in an amount of from 5 to 70% by bulk volume, such as from 10 to 50% by bulk volume, or even from 15 to 25% by bulk volume, based on the total bulk volume of the green body. By “bulk volume” we mean the volume including solid material and pores in the green body.

In the first aspect of the invention, the green body may consist of the third layer. The green body may consist of the first layer and the third layer. The green body may consist of the second layer and the third layer. The green body may consist of the first layer, the second layer and the third layer.

Suitably, in the second aspect of the invention, the green body consists of the first layer and the third layer.

Suitably, in the third aspect of the invention, the green body consists of the first layer, the second layer and the third layer.

The (multilayer) structure may be formed by any suitable method. Suitably, the (multilayer) structure is formed by moulding or extrusion.

The (multilayer) structure may be formed by introducing the first composition (when present), the second composition (when present) and the third composition into a mould. The green body may then be formed by contacting the (multilayer) structure in the mould with the fourth solvent, for example by immersing the mould containing the (multilayer) structure in the fourth solvent.

Suitably, the multilayer structure is formed by first introducing the first composition into the mould, followed by the second composition (when present) and then the third composition, or followed by the third composition and then the second composition (when present), such that the first composition is at least partially covered by the second composition (when present) or the third composition. This arrangement results in the formation of micro-channels in the green body which penetrate through the second layer (when present) and the third layer of the green body, but which terminate in the first layer. The first layer can then be removed to provide a green body with micro-channels penetrating all the way through the green body.

Preferably, the (multilayer) structure is formed by extrusion, for example by forming the (multilayer) structure in an extrusion die and extruding the (multilayer) structure from the die. The (multilayer) structure is suitably extruded directly into the fourth solvent (e.g. such that the (multilayer) structure does not come into contact with air). For example, the outlet of the extrusion die may be immersed in the fourth solvent. Suitably, adjacent layers in the multilayer structure are contacted with one another before the multilayer structure is contacted with the fourth solvent. For example, the extrusion die may contain a chamber in which the adjacent layers of the multilayer structure are contacted before the multilayer structure exits the die. This reduces the likelihood that the layers become detached from each other when the green body is formed. The extrusion may be carried out continuously to form an elongate (multilayer) structure.

The (multilayer) structure may be formed in any suitable shape, such as a pellet, a sheet, or an elongate body. Preferably, the (multilayer) structure is formed as a (multilayer) hollow fibre. The layers in the multilayer hollow fibre are suitably in the form of concentric hollow fibres. Suitably the first composition forms an inner layer and the third composition forms an outer layer in the multilayer hollow fibre.

When the structure consists of the third layer, the structure is preferably formed as a monolayer hollow fibre. The monolayer hollow fibre may be formed by extrusion of the third composition. Suitably the third composition is extruded as a hollow fibre around a bore fluid.

The multilayer hollow fibre may be formed by extrusion of the first composition (when present), the second composition (when present) and the third composition. Suitably the first composition (when present), the second composition (when present) and the third composition are extruded as concentric hollow fibres around a bore fluid.

The bore fluid preferably does not cause precipitation of dissolved polymers in the (multilayer) structure (e.g. the first polymer (when present), the second polymer (when present), the third polymer and the fourth polymer (when present)).

The bore fluid is suitably immiscible with the adjacent layer, such as the first layer, of the (multilayer) structure. Any polymer present in the layer of the (multilayer) structure adjacent to the bore fluid (e.g. the first polymer (when present), the second polymer (when present), the third polymer and the fourth polymer (when present)) is suitably insoluble in the bore fluid. The first polymer is suitably insoluble in the bore fluid.

The bore fluid may be non-aqueous. Suitably the bore fluid comprises a liquid hydrocarbon or a silicone oil. Suitable liquid hydrocarbons include C5-C19 hydrocarbons, such as hexane, heptane, and octane. Suitable silicone oils include polydimethylsiloxane.

The methods of the first, second and third aspects of the invention comprise contacting the (multilayer) structure with a fourth solvent in which the first polymer (when present), second polymer (when present), third polymer and fourth polymer (when present) are insoluble to precipitate said polymers, thereby forming a green body.

Suitably the multilayer structure is contacted with the fourth solvent for less than 30 seconds, such as for less than 10 seconds, or even for less than 1 second, after formation of the multilayer structure. Minimising the time between formation and precipitation of the multilayer structure prevents excessive mixing of adjacent layers in the multilayer structure.

Suitably the volume of the fourth solvent contacted with the (multilayer) structure exceeds the combined volume of the first solvent (when present), the second solvent (when present) and the third solvent in the (multilayer) structure. The volume of the fourth solvent contacted with the (multilayer) structure may be at least two times, such as at least five times, or even at least ten times, the combined volume of the first solvent (when present), the second solvent (when present) and the third solvent in the (multilayer) structure. Suitably, the (multilayer) structure is contacted with a quantity of the fourth solvent sufficient to remove at least 95 wt %, such as at least 98 wt %, or even at least 99 wt %, of the first solvent (when present), the second solvent (when present), and the third solvent from the multilayer structure.

The step of contacting the (multilayer) structure with the fourth solvent may comprise immersing the (multilayer) structure in the fourth solvent, spraying the (multilayer) structure with the fourth solvent, or co-extruding the (multilayer) structure with the fourth solvent. The step of contacting the (multilayer) structure with the fourth solvent preferably comprises immersing the (multilayer) structure in the fourth solvent.

The methods of the first, second and third aspects of the invention may further comprise shaping the green body into a desired shape or size, and/or dividing the green body into a plurality of green bodies. The green body may be shaped and/or divided by any suitable method, such as by cutting the green body. For example, where the (multilayer) structure comprises an elongate (multilayer) structure formed by continuous extrusion, the green body may be cut into a plurality of (shorter) green bodies.

The methods of the first, second and third aspects of the invention suitably further comprise removing the fourth solvent from the green body, for example by drying the green body at a temperature of from 10 to 70° C., such as from 20 to 60° C., or even from 30 to 50° C.

Suitably, the green body is precipitated having the same shape, size and arrangement of layers as the (multilayer) structure from which it is formed.

The method of the third aspect of the invention may comprise:
providing:
a first composition comprising a first polymer and a first solvent, wherein the first polymer is soluble in the first solvent and is immiscible with the second polymer,
a second composition comprising a first substrate material, a second polymer and a second solvent, wherein the second polymer is soluble in the first solvent and the second solvent, and
a third composition comprising a second substrate material, a third polymer, a fusing agent, and a third solvent, wherein the third polymer is soluble in the first solvent and the third solvent, and the fusing agent is miscible with the third polymer;
forming the first composition, the second composition and the third composition into a multilayer structure wherein the first composition forms a first layer, the second composition forms a second layer, the third composition forms a third layer, the second layer is adjacent to the first layer and the second layer is adjacent to the third layer, wherein adjacent layers are in contact with one another; and
contacting the multilayer structure with a fourth solvent in which the first polymer, second polymer, third polymer are insoluble to precipitate said polymers, thereby forming a green body.

The method of the third aspect of the invention may comprise:
providing:
a first composition comprising a first polymer and a first solvent, wherein the first polymer is soluble in the first solvent, and the first polymer comprises a polyester,
a second composition comprising a first substrate material, a second polymer and a second solvent, wherein the second polymer is soluble in the first solvent and the second solvent, and
a third composition comprising a second substrate material, a third polymer, a fourth polymer, and a third solvent, wherein the third polymer and the fourth polymer are soluble in the first solvent and the third solvent, and the fourth polymer comprises an epoxy resin;
wherein the second polymer and third polymer each independently comprise one or more of polyethersulfone, polysulfone, cellulose and its derivatives, polyamide, polyetherimide, polyimide and its derivatives, polyvinylidene fluoride, and polydimethylsiloxane; the first substrate material and the second substrate material each independently comprise one or more of a ceramic, cordierite, zirconia, yttrium-stabilised zirconia, titania, silicon carbide, clay, alumina, stainless steel, FeCr alloys, alloys of iron, alloys of aluminium, aluminium titanate, sintered metals, or a zeolite; and the first solvent, the second solvent and/or the third solvent each independently comprise a dipolar aprotic solvent;
forming the first composition, the second composition and the third composition into a multilayer structure wherein the first composition forms a first layer, the second composition forms a second layer, and the third composition forms a third layer and the second layer is adjacent to the third layer; and
contacting the multilayer structure with a fourth solvent in which the first polymer, second polymer, third polymer and fourth polymer are insoluble to precipitate said polymers, thereby forming a green body, wherein the fourth solvent comprises a polar protic solvent.

The method of the third aspect of the invention may comprise:
providing:
a first composition comprising a first polymer and a first solvent, wherein the first polymer is soluble in the first solvent,
a second composition comprising a first substrate material, a second polymer and a second solvent, wherein the second polymer is soluble in the first solvent and the second solvent, and
a third composition comprising a second substrate material, a third polymer, a fusing agent, and a third solvent, wherein the third polymer is soluble in the first solvent and the third solvent;
wherein the first substrate material and the second substrate material are the same; the second polymer and the third polymer are the same; the second solvent and the third solvent are the same; and the second composition is substantially free from the fusing agent;
forming the first composition, the second composition and the third composition into a multilayer structure wherein the first composition forms a first layer, the second composition forms a second layer, and the third composition forms a third layer and the second layer is adjacent to the third layer; and
contacting the multilayer structure with a fourth solvent in which the first polymer, second polymer and third polymer are insoluble to precipitate said polymers, thereby forming a green body.

According to a fourth aspect of the invention, there is provided a green body obtained by the method of the first, second or third aspect of the invention.

The present invention also provides a green body obtainable by the method of the first, second or third aspect of the invention.

According to a fifth aspect of the invention, there is provided a method of manufacturing a substrate, the method comprising the steps of:
manufacturing a green body according to the first, second or third aspect of the invention;
arranging the green body with a plurality of green bodies to form an assembly of green bodies;
fusing the green bodies in the assembly together, thereby forming a precursor substrate; and
sintering the precursor substrate, thereby forming a substrate.

The method of the fifth aspect of the invention comprises arranging a green body manufactured according to the first, second or third aspect of the invention with a plurality of green bodies to form an assembly of green bodies. By “assembly of green bodies”, we mean a predetermined arrangement of the green bodies. By “plurality of green bodies”, we mean 2 or more, such as 100 or more, or even 1000 or more of the green bodies. The assembly may comprise a regular repeating pattern of the green bodies.

The plurality of green bodies suitably comprises one or more green bodies manufactured according to the first, second or third aspect of the invention, such that the assembly comprises a plurality of green bodies manufactured according to the first, second or third aspect of the invention. Suitably, at least 10%, such as at least 50%, such as at least 90%, or even 100% of the green bodies in the assembly are manufactured according to the first, second or third aspect of the invention.

The assembly may comprise green bodies having different shapes and/or sizes. Alternatively, the assembly may comprise green bodies the same shape and/or size. For example, the assembly may comprise a plurality of green bodies manufactured according to the first, second or third aspect of the invention in the form of hollow fibres of the same shape and size, for example arranged to form a cylinder or oval prism.

The assembly may comprise an additional green body not manufactured according to the second or third aspect of the invention. For example, the assembly may comprise a single layer green body prepared by contacting a second composition or a third composition with a fourth solvent. The preferred features of the second composition, the third composition and the fourth solvent are as described in relation to the first, second and third aspects of the invention. Suitably, the assembly comprises a single layer green body prepared by contacting a third composition with a fourth solvent. Preferably the third composition used to prepare the green bodies according to the second or third aspect of the invention and the third composition used to prepare the single layer green body are the same. The additional green body may be a green body manufactured according to the first aspect of the invention. The assembly may comprise a plurality of the additional green body.

The additional green body may have any suitable shape, such as a sheet or a hollow shape, such as a hollow cylinder or tube having a circular, oval, square or rectangular cross section. Suitably, the additional green body has a shape adapted to encompass the plurality of green bodies manufactured according to the first, second or third aspect of the invention. The additional green body is suitably placed around the plurality of the green bodies manufactured according to the first, second or third aspect of the invention, i.e. so as to encompass the plurality of green bodies manufactured according to the first, second or third aspect of the invention. This improves the strength of the substrate ultimately obtained.

The green bodies in the assembly are suitably in contact with one another. Preferably, the green bodies are in contact via the third layer of the green bodies.

The assembly may comprise a plurality of parallel, contacting green bodies manufactured according to the first, second or third aspect of the invention in the form of hollow fibres. An outer surface of the hollow fibres is suitably the third layer thereof. The hollow fibres in the plurality of parallel, contacting green bodies are suitably linear. The plurality of parallel, contacting green bodies in the form of hollow fibres may be housed in an additional green body adapted to encompass said plurality, which is suitably prepared by contacting the third composition with the fourth solvent.

The assembly may comprise a plurality of contacting green bodies manufactured according to the first, second or third aspect of the invention in the form of hollow fibres. An outer surface of the hollow fibres is suitably the third layer thereof. The hollow fibres in the plurality of parallel, contacting green bodies are suitably non-linear. The hollow fibres may be curved. The hollow fibres may be curved by any suitable means. The hollow fibres may be curved by weaving or braiding the hollow fibres together, or by twisting a plurality of linear, parallel hollow fibres (suitably about the longitudinal axis of the plurality of hollow fibres). The plurality of hollow fibres suitably comprises from 10 to 50, such as from 15 to 45, or even from 19 to 37 hollow fibres. A plurality comprising more than 50 non-linear hollow fibres may be more difficult to arrange.

The presence of polymers in the hollow fibres makes the hollow fibres flexible, advantageously allowing the hollow fibres to be curved and arranged into a plurality of non-linear hollow fibres as described above. This is not possible with green bodies that do not comprise polymers, such as ceramic green bodies. Non-linear hollow fibres may advantageously create turbulent flow in a fluid flowing through the hollow fibre, such as by the formation of Dean vortices in the fluid. This may allow more of the fluid to contact the walls of the hollow fibre, which is desirable if the hollow fibre is intended to be used as part of a catalytic converter or filter.

The plurality of contacting green bodies in the form of non-linear hollow fibres may be housed in an additional green body adapted to encompass said plurality, which is suitably prepared by contacting the third composition with the fourth solvent. When the plurality of green bodies is formed by twisting a plurality of linear, parallel hollow fibres, housing the plurality in the additional green body advantageously helps to hold the twisted plurality in place until fusion of the green bodies can take place.

The method of the fifth aspect of the invention comprises fusing the green bodies in the assembly together, thereby forming a precursor substrate.

The green bodies may be fused in any suitable way, for example by heating the assembly or by contacting the assembly with a fifth solvent. Preferably the green bodies are fused by heating the assembly. Suitable ways of fusing the green bodies involve causing at least a portion of the third layers of the green bodies to soften and merge with one another. Suitably, at least a portion of the third layers is merged by at least 10%, such as at least 30%, for example at least 50% of the initial thickness of the third layers (i.e. the thickness of the third layers prior to merging).

The green bodies may be fused by heating the assembly to a temperature at which the third layer of the green bodies softens (e.g. above the glass transition temperature of the third layer).

Once the third layer of a green body has become soft, it can merge with the third layer of another green body, thereby fusing the green bodies in the assembly together once the temperature is reduced. The green bodies may be fused by heating the assembly to a temperature of from 50 to 300° C., such as from 100 to 250° C., or even from 130 to 170° C.

The green bodies may be fused by contacting the assembly with a fifth solvent. Suitably the fusing agent is soluble in the fifth solvent and the third polymer is insoluble in the fifth solvent. The effect of this is that the fifth solvent causes the third layers of the green bodies in the assembly to soften and merge with one another. Suitably the first polymer (when present) and the second polymer (when present) are also insoluble in the fifth solvent.

Advantageously the green bodies can be fused under conditions that do not cause a softening of the second layer (when present). Therefore the green bodies may be fused while maintaining their shape.

Suitably, the green bodies are urged together whilst being fused. The green bodies may be urged together by compressing the assembly. For example, the assembly may be compressed by wrapping the assembly in a compression device. Suitable compression devices include a resilient band or sleeve (such as a silicone rubber band), a resilient tape (such as a spiral wound silicone tape), an inflatable bladder (such as a silicone bladder), or a mould. Urging the green bodies together improves the fusing thereof.

The method of the fifth aspect of the invention may further comprise removing the first polymer (when present) from the green body, the assembly, or the precursor substrate. This step may be carried out before the second polymer (when present), the third polymer and the fourth polymer (when present) are removed from the precursor substrate during the sintering step or during a pre-sintering heating step. Preferably, the first polymer is removed from the green body before the green body is arranged into the assembly. The first polymer may be removed by any suitable means, such as manually, mechanically or by dissolution. The first polymer may be manually or mechanically pulled or peeled from the green body, the assembly, or the precursor substrate in order to remove the first polymer. Alternatively, the first polymer may be removed by dissolving the first polymer in a sixth solvent. Suitably, the first polymer is soluble in the sixth solvent and the second polymer (when present), the third polymer and the fourth polymer (when present) are insoluble in the sixth solvent.

When the first composition comprises a substrate material, the method of the fifth aspect of the invention preferably does not comprise removing the first polymer from the green body, the assembly, or the precursor substrate.

Suitably, the green body may be in the form of a hollow fibre comprising the first layer as an inner layer enveloping a bore fluid. The method may comprise removing the first layer from the green body, the assembly, or the precursor substrate together with the bore fluid. This prevents the bore fluid from being present during sintering where it may contaminate the substrate during sintering if the bore fluid is not volatile or combustible (for example when the bore fluid comprises a silicone oil).

The method of the fifth aspect of the invention may further comprise heating the precursor substrate to remove organic polymers from the precursor substrate prior to sintering. This step is preferably carried out when the second polymer (when present), the third polymer and the fourth polymer (when present) are organic polymers. In order to remove organic polymers from the precursor substrate, the precursor substrate is suitably heated to a temperature of from 300 to 800° C., such as from 400 to 700° C., or even from 500 to 600° C. Preferably the heating is carried out under an oxygen-containing atmosphere, such as air. At these temperatures, the organic polymers typically ‘burn off’.

The method of the fifth aspect of the invention comprises sintering the precursor substrate, thereby forming a substrate.

The precursor substrate may be sintered at a temperature of at least 1000° C., such as at least 1200° C., or even at least 1300° C. The precursor substrate may be sintered at a temperature of from 1000 to 1600° C., such as from 1200 to 1500° C., or even from 1300 to 1400° C. The sintering is suitably carried out under an oxygen-containing atmosphere, such as air.

The substrate formed by the method of the fifth aspect of the invention is suitably free from polymers and solvents. The substrate may consist of the first substrate material (when present) and the second substrate material. Suitably, the substrate is porous and comprises micro-channels. Suitably, the substrate comprises pores having a pore size of from 0.1 to 5 μm, such as from 0.3 to 3 μm, or even from 0.5 to 1 μm. Suitably, the micro-channels extend from one surface of the substrate to another and have an entrance diameter of from 5 μm to 200 μm. Preferably, the micro-channels penetrate from one surface of the substrate to another. In some embodiments, the micro-channels do not penetrate from one surface of the substrate to another.

In such embodiments, the micro-channels suitably only extend from 30 to 99%, such as from 50 to 95%, for example from 70 to 90% of the thickness of the substrate.

The substrate may comprise two or more layers having different micro-channel geometries. For example, the substrate may comprise a first substrate layer having micro-channels having an entrance diameter of from 5 to 20 μm, such as from 5 to 15 μm, or even from 5 to 10 μm and a second substrate layer having micro-channels having an entrance diameter of from 20 to 200 μm, such as from 30 to 200 μm, or even from 50 to 200 μm. It is believed that the micro-channel geometries of a substrate layer can be varied by selecting the viscosities of the second composition (when present) and the third composition.

The substrate may comprise macro-channels penetrating from one surface of the substrate to another. The substrate may comprise micro-channels penetrating all the way through the walls of the macro-channels. In some embodiments, the micro-channels in the substrate do not penetrate all the way through the walls of the macro-channels. In such embodiments, the micro-channels suitably only extend from 30 to 99%, such as from 50 to 95%, for example from 70 to 90% of the thickness of the walls of the macro-channels.

Suitably, the substrate comprises a plurality of fused hollow fibres. Suitably, the substrate comprises a plurality of parallel, fused hollow fibres, preferably wherein the hollow fibres are linear. Alternatively, the substrate may comprise a plurality of fused hollow fibres wherein the fibres are non-linear.

The method of the fifth aspect of the invention may comprise:
manufacturing a green body according to the first, second or third aspect of the invention;
arranging the green body with a plurality of green bodies to form an assembly of green bodies, wherein the green bodies in the assembly are in contact with one another via the third layer of the green bodies;
fusing the green bodies in the assembly together by heating the assembly, wherein the green bodies are urged together whilst being fused, thereby forming a precursor substrate;
heating the precursor substrate to remove organic polymers from the precursor substrate prior to sintering; and
sintering the precursor substrate, thereby forming a substrate.

The method of the fifth aspect of the invention may comprise:
manufacturing a green body according to the first, second or third aspect of the invention;
arranging the green body with a plurality of green bodies to form an assembly of green bodies, wherein the green bodies in the assembly are in contact with one another via the third layer of the green bodies;
fusing the green bodies in the assembly together by heating the assembly to a temperature of from 50 to 300° C., wherein the green bodies are urged together whilst being fused, thereby forming a precursor substrate;
heating the precursor substrate to a temperature of from 300 to 800° C. to remove organic polymers from the precursor substrate prior to sintering; and
sintering the precursor substrate at a temperature of at least 1000° C., thereby forming a substrate.

According to a sixth aspect of the invention, there is provided a substrate obtained by the method of the fifth aspect of the invention.

Suitably, the substrate of the sixth aspect is obtained by:
manufacturing a green body according to the third aspect of the invention;
arranging the green body with a plurality of green bodies to form an assembly of green bodies;
fusing the green bodies in the assembly together, thereby forming a precursor substrate; and sintering the precursor substrate, thereby forming the substrate.

The present invention also provides a substrate obtainable by the method of the fifth aspect of the invention.

According to a seventh aspect of the invention, there is provided a method of manufacturing a filter, the method comprising manufacturing a substrate according to the fifth aspect of the invention and blocking at least some macro-channels in the substrate.

When macro-channels are blocked, the composition being filtered (such as a fluid, for example an exhaust gas or water) is forced through the channel walls such that solid particles larger than the pores which are carried in a fluid being passed through the substrate become trapped in the substrate. The substrate can therefore act as a filter for such particles.

Suitably, the method comprises blocking at least 50%, such as at least 70%, or even at least 90%, of macro-channels penetrating from one surface of the substrate to another. Preferably, the method comprises blocking all macro-channels penetrating from one surface of the substrate to another. Suitably, adjacent macro-channels are blocked at different surfaces of the substrate.

A substrate comprising a plurality of fused hollow fibres may comprise a plurality of macro-channels, which macro-channels may be blocked. The macro-channels may correspond to the hollow portion of the hollow fibres and the voids between the hollow fibres. A substrate comprising a plurality of parallel, fused hollow fibres may comprise a plurality of parallel macro-channels, which macro-channels may be blocked. When the fused hollow fibres are non-linear, the macro-channels in the substrate are suitably non-linear. Non-linear macro-channels may advantageously create turbulent flow in a fluid flowing through the macro-channels.

Suitably, when the substrate comprises micro-channels penetrating from one surface of the substrate to another, such as micro-channels penetrating all the way through the walls of the macro-channels, and the method of the seventh aspect comprises blocking at least some of the micro-channels. Suitably, the method comprises blocking at least 50%, such as at least 70%, or even at least 90%, of the micro-channels penetrating from one surface of the substrate to another. Preferably, the method comprises blocking all micro-channels penetrating from one surface of the substrate to another.

The method of the seventh aspect of the invention may further comprise depositing a coating on the substrate. The coating may change the filtration properties of the substrate, such as reducing the size of particles that can pass through the substrate. The coating may comprise a refractory material. As used herein, the term “refractory material” is used in its ordinary sense, which is well-known to those skilled in the art. Specifically, a refractory material is a material that is resistant to high temperatures (such as above 538° C.). The refractory material suitably comprises alumina, silica, titania, silicon carbide and/or zirconia. Such materials may be used for water filtration. The coating may comprise a dense ceramic material. By “dense ceramic material” we mean a ceramic material which does not comprise pores which form a path through the material. Movement of a substance through the dense ceramic material may only occur through atomic or ionic diffusion through the bulk dense ceramic material. The dense ceramic material may be used for the separation of gases. The dense ceramic material may comprise yttrium stabilised zirconia or zirconia doped with yttrium, which may be used for oxygen separation.

The method of the seventh aspect of the invention may further comprise depositing a catalytic species or precursor thereof on the substrate, for example as described in relation to the tenth aspect of the invention below, in order to manufacture a combined filter-catalytic convertor. In the combined filter-catalytic convertor, the filter and catalytic convertor components may comprise the same or different substrates.

In some embodiments, the method of the seventh aspect of the present invention does not comprise depositing a catalytic species or a precursor thereof on the substrate. In some embodiments, the method of the seventh aspect does not comprise depositing a coating on the substrate.

According to an eighth aspect of the invention, there is provided a method of filtering, the method comprising manufacturing a filter according to the seventh aspect of the invention and passing a composition through the filter.

The composition passed through the filter suitably comprises a mixture of substances, such as a solid and a liquid, a solid and a gas, a liquid and a gas, a mixture of solids, a mixture of liquids, and/or a mixture of gases. The filter suitably retains at least one of the substances in the mixture, while allowing other substances in the mixture to pass through. Suitably, the composition comprises a liquid or a gas. Preferably, the composition comprises a mixture of a solid and a gas or a mixture of a solid and a liquid. Alternatively, the composition may comprise a liquid and a gas, a mixture of liquids, and/or a mixture of gases.

Suitably, the composition passed through the filter comprises solid particles to be filtered, i.e. solid particles larger than the pores in the substrate. For example, the composition may comprise particles of soot. The composition may be exhaust fumes, such as from an internal combustion engine. Preferably, the internal combustion engine is a diesel or gasoline engine. For example, the composition may comprise an aqueous composition that comprises particulates.

The method of the eighth aspect of the invention may further comprise regenerating the filter by removing solid particles that have been trapped by the filter. Regeneration may be carried out by heating the filter to combust the solid particles. The filter may be heated to a temperature of at least 300° C., such as at least 400° C., or even at least 500°. Suitably the filter is heated to a temperature of from 300 to 800° C., such as from 400 to 700° C., or even from 500 to 600° C.

The method of the eighth aspect of the invention may comprise manufacturing a combined filter-catalytic convertor and passing a pollutant composition through the combined filter-catalytic convertor. In the combined filter-catalytic convertor, the filter and catalytic convertor components may comprise the same or different washcoated substrates. Preferred features of the pollutant composition may be as defined herein.

Suitably, the composition passed through the filter comprises a liquid. The composition may comprise a liquid and solid particles, such as solid particles larger than the pores in the substrate. The liquid may comprise water and/or an organic solvent, such as an alcohol. Preferably, the liquid comprises water. The method of the eighth aspect of the invention may be a method of filtering water. Suitably, the filter through which the composition is passed does not comprise a catalytic species or a precursor thereof.

In embodiments where the composition passed through the filter comprises a liquid or a gas, in particular when the composition comprises a liquid and a gas, a mixture of liquids, and/or a mixture of gases, the filter suitably comprises a coating as described in relation to the seventh aspect of the present invention. For example, when the composition passed through the filter comprises water, the coating suitably comprises a refractory material such as alumina, silica, titania, silicon carbide and/or zirconia. In another example, when the composition passed through the filter comprises a mixture of gases, the coating suitably comprises a dense ceramic material, such as yttrium stabilised zirconia. The method of the eighth aspect of the invention may be a method of separating gases.

According to a ninth aspect of the invention, there is provided a filter comprising a substrate according to the sixth aspect of the invention.

The filter may be a diesel particulate filter or a gasoline particulate filter.

Alternatively, the filter may be a filter for liquid, such as a water filter. The filter for liquid suitably comprises a coating comprising a refractory material, such as alumina, silica, titania, silicon carbide and/or zirconia. The filter may comprise a coating comprising a suitable form of silver (such as silver ions) that acts to eradicate bacteria in the filter and material being filtered.

Alternatively, the filter may be a filter for the separation of gases, such as the separation of oxygen. The filter for the separation of gases suitably comprises a coating comprising a dense ceramic material, such as yttrium stabilised zirconia or zirconia doped with yttrium

According to a tenth aspect of the invention, there is provided a method of manufacturing a catalytic convertor, the method comprising manufacturing a substrate according to the fifth aspect of the invention and depositing a catalytic species or precursor thereof on the substrate.

The catalytic species or precursor thereof is suitably deposited by coating the substrate with a washcoat comprising the catalytic species or precursor thereof, or by contacting a washcoated substrate with an aqueous solution of the catalytic species (for example salt of a platinum group metal), such that the aqueous solution is drawn into the pores of the washcoated substrate by capillary action and upon drying the salt ions combine to form agglomerates of the salt. These agglomerates are suitably then converted to platinum group metal by heating, for example to a temperature of 425 to 475° C.

Suitable catalytic species may comprise a platinum group metal, for example selected from platinum, palladium or rhodium, or a combination thereof.

According to an eleventh aspect of the invention, there is provided a method of catalytic conversion of pollutants, the method comprising manufacturing a catalytic convertor according to the tenth aspect of the invention and passing a pollutant composition through the catalytic convertor.

The pollutant composition may comprise one or more of particulate matter, hydrocarbons, carbon monoxide, and nitrogen oxides. Suitably, the pollutant composition is exhaust fumes, such as from an internal combustion engine. The internal combustion engine may be a gasoline engine or a diesel engine.

According to a twelfth aspect of the invention, there is provided a catalytic convertor comprising a substrate according to the sixth aspect of the invention.

According to a thirteenth aspect of the invention, there is provided a method of manufacturing an exhaust system, the method comprising:
manufacturing a filter according to the seventh aspect of the invention and incorporating the filter into an exhaust system; and/or
manufacturing a catalytic convertor according to the tenth aspect of the invention and incorporating the catalytic convertor into an exhaust system.

According to a fourteenth aspect of the invention, there is provided an exhaust system comprising a filter according to the ninth aspect of the invention and/or a catalytic convertor according to the twelfth aspect of the invention.

In the thirteenth or fourteenth aspect of the invention, the exhaust system is suitably a vehicle exhaust system. The exhaust system may comprise an exhaust manifold, piping, a silencer, and/or an exhaust pipe.

According to a fifteenth aspect of the invention, there is provided a method of manufacturing a product including an internal combustion engine (such as a vehicle), the method comprising manufacturing an exhaust system according to the thirteenth aspect of the invention and incorporating the exhaust system into a product including an internal combustion engine (such as a vehicle).

According to a sixteenth aspect of the invention, there is provided a product including an internal combustion engine (such as a vehicle) comprising an exhaust system according to the thirteenth aspect of the invention.

Examples of products including an internal combustion engine include vehicles and generators.

The present invention also provides a method of manufacturing a vehicle, the method comprising manufacturing an exhaust system according to the thirteenth aspect and incorporating the exhaust system into a vehicle.

The present invention also provides a vehicle comprising an exhaust system according to the fourteenth aspect of the invention.

The vehicle suitably comprises an internal combustion engine, such as a diesel engine or a gasoline engine. Examples of suitable vehicles include motorcycles, cars, vans, buses, lorries, boats, ships, industrial vehicles and agricultural vehicles.

The invention will now be described with reference to the following non-limiting examples.

### BRIEF DESCRIPTION OF THE DRAWINGS

For a better understanding of the invention, and to show how example embodiments may be carried into effect, reference will now be made to the accompanying drawings in which:

FIG. 1 shows a photograph of a cross section of a hollow fibre substrate manufactured according to the method of the fifth aspect of the invention.

FIG. 2 shows a photograph of a cross section of a substrate manufactured according to the fifth aspect of the invention.

### EXAMPLES

### Example 1

### 1. Preparation of Extrusion Feeds

### 1.1 Bore Fluid

Dimethicone (polydimethylsiloxane) with a viscosity between 5 and 500 cSt was transferred to an air-tight reservoir and degassed under vacuum for about 1 hour.

### 1.2 First Composition

20 wt % polycaprolactone (PCL) with a weight average molecular weight of 55,000 g/mol was mixed with 80 wt % n-methyl-2-pyrrolidone (NMP) and stirred at about 60° C. for 3 hours under vacuum. The solution was then transferred to an air-tight reservoir.

### 1.3 Second Composition

44.85 wt % aluminium oxide (alumina) with a particle size between 0.1 and 1 μm was added to 43.60 wt % dimethylsulfoxide (DMSO) and 0.34 wt % Cithrol DPHS dispersant (PEG-30 dipolyhydroxystearate). The materials were then mixed at high shear (4000 rpm) at about 40° C. for about 4 hours. After mixing at high shear 11.21 wt % polyethersulfone (PES, Mw=58,000 g/mol) was added and stirring was continued at about 2000 rpm. The mixed suspension was then transferred to a gas tight reservoir and vacuum was applied until no bubbles could be seen at the surface.

### 1.4 Third Composition

39.88 wt % aluminium oxide (alumina) with a particle size between 0.1 and 1 μm was added to 39.88 wt % dimethylsulfoxide (DMSO) and 0.30 wt % Cithrol DPHS dispersant. The materials were then mixed at high shear (4000 rpm) at about 40° C. for about 4 hours. After mixing at high shear 9.97 wt % polyethersulfone (PES, Mw=58,000 g/mol) and 9.97 wt % bisphenol-A-diglycidyl ether (Epon 828, Mn=700 g/mol) were added and stirring was continued at about 2000 rpm. The mixed suspension was then transferred to a gas tight reservoir and vacuum was applied until no bubbles could be seen at the surface.

### 2. Extrusion

The extrusion feed reservoirs were pressurized to about 50 kPa (0.5 bar) to supply material to progressive cavity pumps for the first composition, the second composition and the third composition and to syringe pumps for the bore fluid.

The four extrusion feeds were pumped to an extrusion die. The flow rates were 13 mL/min, 3 mL/min, 10 mL/min, 4 mL/min for the bore fluid, the first composition, the second composition, and the third composition, respectively. The fluids were pumped through four concentric internal nozzles in the die and exited the die through a single outlet immersed in a water tank. The fluids exited the die in the form of a cylinder with concentric layers, the order of the layers being the bore fluid, the first composition, the second composition, and the third composition from innermost to outermost.

Contact with the water caused the four fluids exiting the die to solidify, forming a solid, polymer/ceramic, flexible mixed matrix tube (hollow fibre) with an outer diameter of about 3.5 mm and an inner diameter of about 2 mm. The hollow fibre was drawn from the water and lengths of fibre were cut therefrom and deposited into another container of water.

### 3. Post Extrusion Fibre Processing

The collected fibres were soaked in water for about 12 hours with agitation to remove the remaining solvent from the hollow fibre green body. A small portion of the end of the fibres was removed to expose the first layer (precipitated from the first composition), which formed a continuous polymer layer separated from the second layer (precipitated from the second composition). The first layer was removed manually by pulling one end. After removal of the first layer, the fibres were soaked in water and surfactant (15-30% anionic surfactants and 5-15% non-ionic surfactants) with agitation to remove traces of the dimethicone (bore fluid). The fibres were then dried at a temperature between 30° C. and 80° C.

### 4. Assembly

Dry fibres were placed vertically on a template consisting of 5 mm long pins arranged so that the outer surfaces of the fibres were in contact and the fibres were arranged in a hexagonal close packed configuration. For a final substrate diameter of 85 mm (post-sintering), 1040 fibres having a total diameter of 115 mm were arranged on the template and 3 silicone rubber bands with a diameter of about 100 mm were placed around the outside of the assembly of fibres. After the bands were in place the assembly was removed from the template. The assembly was placed in a preheated oven at 150° C. for 2 hours. After heating, the assembly was allowed to cool to room temperature and the silicone bands were removed. The result was a fused precursor substrate.

### 5. Heat Treatment

The precursor substrate was heated in a furnace according to the following steps.

Step 1: The precursor substrate was heated from 20° C. to 250° C. at a rate of 0.5° C./min.

Step 2: The substrate was held at 250° C. for 1 hour to control exothermic reactions in the substrate.

Step 3: The substrate was heated from 250° C. to 440° C. at a rate of 0.5° C./min.

Step 4: The substrate was held as 440° C. for 15 hours to remove the Epon 828 and to partially remove the polyethersulfone.

Step 5: The substrate was heated from 440° C. to 540° C. at a rate of 0.5° C./min, during which time the remaining polyethersulfone was removed.

Step 6: The substrate was heated from 540° C. to 1350° C. at a rate of 5° C./min.

Step 7: The substrate was held at 1350° C. for 4 hours to sinter the substrate.

Step 8: The substrate was cooled from 1350° C. to 20° C. at a rate of 5° C./min to obtain a cooled, sintered substrate.

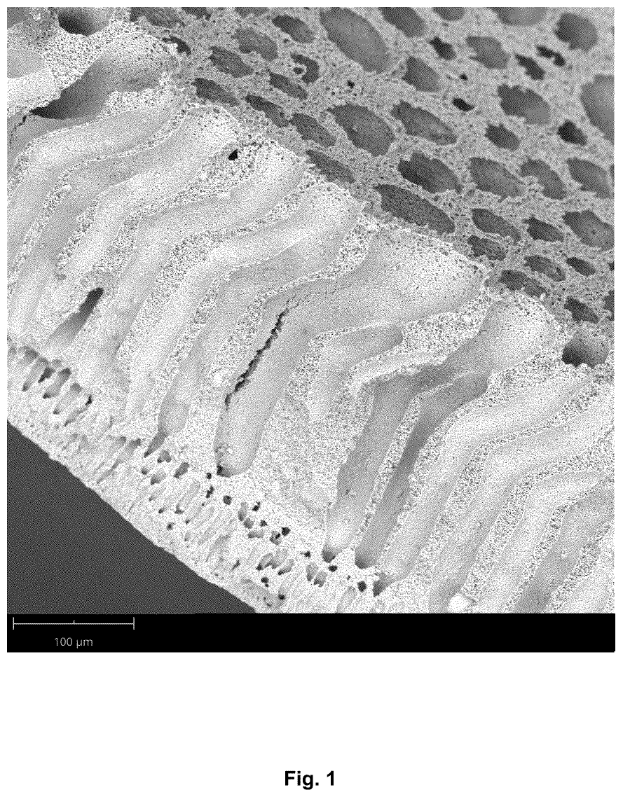

FIG. 1 shows a cross section of the wall of a sintered hollow fibre made by the above method. It can be seen that the follow fibre contains two layers: an outer layer with narrower micro-channels precipitated from the third composition, and an inner layer with wider micro-channels (ranging from 20 μm to 100 μm in width) precipitated from the second composition.

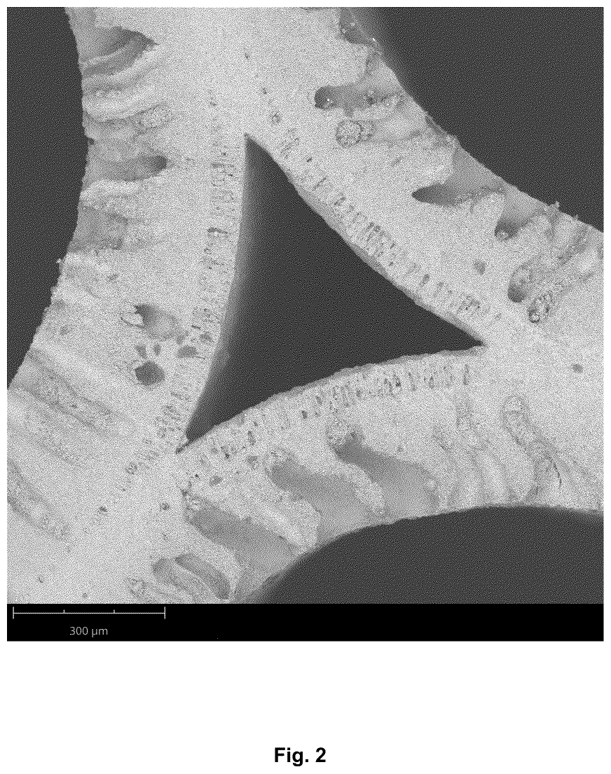

FIG. 2 shows a cross section of the sintered substrate made by the above method. The junction between three hollow fibres is shown. It can be seen that the layer precipitated from the third composition has merged such that the hollow fibres are fused together. Although not shown, the fused region of the hollow fibres also contains micro-channels.

FIGS. 1 and 2 were obtained from a Phenom ProX desktop scanning electron microscope. The detector type was backscatter, with an accelerating voltage of 10 kV.

### Example 2

Steps 1 to 3 were carried out as for Example 1.

### 4. Substrate Skin Fabrication

A portion of the third composition was poured into a mould with length, width, height of 115 mm, 80 mm and 3 mm respectively. The mould had 5 sides, i.e. the top side of the mould was open. The mould containing the suspension was then immersed in water to solidify the suspension, the mould and solidified suspension were left in water until all suspension solvent had been removed. The solidified suspension was removed from the mould and dried at 30° C. for 3 hours to produce a green sheet of polymer/ceramic material.

The sheet was heated at 100° C. for 10 minutes so that it became soft and pliable after which it was wrapped around a 115 mm diameter cylinder and allowed to cool. On cooling the sheet retained the cylindrical shape of the cylinder.

### 5. Assembly

Dry fibres were placed vertically on a template consisting of 5 mm long pins arranged so that the outer surfaces of the fibres were in contact and the fibres were arranged in a hexagonal close packed configuration. For a final substrate diameter of 85 mm (post-sintering), 1040 fibres having total diameter of 115 mm were arranged on the template and the cylindrical sheet made in step 4 was placed around the fibres to form an assembly. 3 silicone rubber bands with a diameter of about 100 mm were placed around the assembly. After the bands were in place the assembly was removed from the template. The assembly was placed in a preheated oven at 150° C. for 2 hours. After heating, the assembly was allowed to cool to room temperature and the silicone bands were removed. The result was a fused precursor substrate.

### 6. Heat Treatment

The assembly was heat treated as described in Example 1 to obtain a cooled, sintered substrate.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A method of manufacturing a green body, the method comprising:
providing:
a third composition comprising a second substrate material, a third polymer, a fusing agent, and a third solvent;
forming the third composition into a structure wherein the third composition forms a third layer; and
contacting the third layer with a fourth solvent in which the third polymer is insoluble to precipitate said polymer, thereby forming a green body.

2. A method of manufacturing a green body, the method comprising:
providing:
a first composition comprising a first polymer and a first solvent, wherein the first polymer is soluble in the first solvent,
a third composition comprising a second substrate material, a third polymer, a fusing agent, and a third solvent, wherein the third polymer is soluble in the first solvent and the third solvent;
forming the first composition and the third composition into a multilayer structure wherein the first composition forms a first layer and the third composition forms a third layer; and
contacting the multilayer structure with a fourth solvent in which the first polymer and third polymer are insoluble to precipitate said polymers, thereby forming a green body.

3. A method of manufacturing a green body, the method comprising:
providing:
a first composition comprising a first polymer and a first solvent, wherein the first polymer is soluble in the first solvent,
a second composition comprising a first substrate material, a second polymer and a second solvent, wherein the second polymer is soluble in the first solvent and the second solvent, and
a third composition comprising a second substrate material, a third polymer, a fusing agent, and a third solvent, wherein the third polymer is soluble in the first solvent and the third solvent;
forming the first composition, the second composition and the third composition into a multilayer structure wherein the first composition forms a first layer, the second composition forms a second layer, and the third composition forms a third layer and the second layer is adjacent to the third layer; and
contacting the multilayer structure with a fourth solvent in which the first polymer, second polymer, and third polymer are insoluble to precipitate said polymers, thereby forming a green body.

4. The method of claim 3, wherein the first polymer is immiscible with at least one of the second polymer and the third polymer.

5. The method of claim 3, wherein the second polymer and the third polymer are the same.

6. The method of claim 1, wherein the fusing agent is miscible with the third polymer.

7. The method of claim 3, wherein the first substrate material and/or the second substrate material each independently comprises one or more of: a ceramic, cordierite, zirconia, yttrium-stabilised zirconia, titania, silicon carbide, clay, alumina, stainless steel, FeCr alloys, alloys of iron, alloys of aluminium, aluminium titanate, sintered metals, or a zeolite.

8. The method of claim 3, wherein the second layer is adjacent to the first layer and is adjacent to the third layer in the multilayer structure

9. The method of claim 1, wherein the (multilayer) structure is formed by moulding or extrusion.

10. The method of claim 1, wherein the (multilayer) structure is formed as a (multilayer) hollow fibre.

11. A method of manufacturing a substrate, the method comprising the steps of:
manufacturing a green body according to claim 1;
arranging the green body with a plurality of green bodies to form an assembly of green bodies;
fusing the green bodies in the assembly together, thereby forming a precursor substrate; and
sintering the precursor substrate, thereby forming a substrate.

12. The method of claim 11, wherein the assembly comprises green bodies having different shapes and/or sizes.

13. The method of claim 11, wherein the green bodies are fused by heating the assembly or by contacting the assembly with a fifth solvent.

14. The method of claim 11, further comprising removing the first polymer from the green body, the assembly, or the precursor substrate.

15. The method of claim 11, further comprising heating the precursor substrate to remove organic polymers from the precursor substrate prior to sintering.

16. The method of claim 15, wherein the precursor substrate is heated to a temperature of from 300 to 800° C.

17. The method of claim 11, wherein the precursor substrate is sintered at a temperature of at least 1000° C.

18. A green body obtained by the method of claim 1.

19. A method of manufacturing a filter, the method comprising manufacturing a substrate according to claim 11 and blocking at least some macro-channels in the substrate.

20. A method of filtering, the method comprising manufacturing a filter according to claim 19 and passing a composition through the filter.

21. The method of claim 20, wherein the composition comprises a liquid, preferably wherein the liquid comprises water.

22. A filter comprising a substrate according to claim 18.

23. A method of manufacturing a catalytic convertor, the method comprising manufacturing a substrate according to claim 11 and depositing a catalytic species or precursor thereof on the substrate.

24. A method of catalytic conversion of pollutants, the method comprising manufacturing a catalytic convertor according to claim 23 and passing a pollutant composition through the catalytic convertor.

25. A catalytic convertor comprising a substrate according to claim 18.

26. A method of manufacturing an exhaust system, the method comprising:
manufacturing a filter and incorporating the filter into an exhaust system; and/or
manufacturing a catalytic convertor and incorporating the catalytic convertor into an exhaust system,
wherein the filter is manufactured by a method comprising manufacturing a substrate according to claim 11 and blocking at least some macro-channels in the substrate and
wherein the catalytic convertor is manufactured by a method comprising manufacturing a substrate according to claim 11 and depositing a catalytic species or precursor thereof on the substrate.

27. A method of manufacturing a product including an internal combustion engine, the method comprising manufacturing an exhaust system according to claim 26 and incorporating the exhaust system into a product including an internal combustion engine.

28. A substrate obtained by the method of claim 11.
